(19) United States
(12) Patent Application Publication
(10) Pub. No.: US 2018/0292836 A1
(43) Pub. Date: Oct. 11, 2018

(54) AUTOMATED VEHICLE OPERATION-RULES SELECTED BASED ON AUTOMATION-LEVEL OTHER VEHICLES

(71) Applicant: Delphi Technologies, Inc., Troy, MI (US)

(72) Inventors: Michael H. Laur, Mission Viejo, CA (US); Indu Vijayan, Sunnyvale, CA (US)

(21) Appl. No.: 15/480,499

(22) Filed: Apr. 6, 2017

(51) Int. Cl. G05D 1/02; B60W 30/16; B60W 30/18

(52) U.S. Cl. CPC G05D 1/0223; G05D 1/0088; B60W 30/18163; B60W 30/16

(57) ABSTRACT

A system for operating an automated vehicle in accordance with an operation-rules that are based on an automation-level of an other-vehicle includes an automation-detector and a controller. The automation-detector conveys an automation-level indicated by an other-vehicle proximate to a host-vehicle. The controller is in communication with the automation-detector. The controller operates the host-vehicle in accordance with an operation-rule that is selected based on the automation-level of the other-vehicle. For example, the controller operates the host-vehicle to follow the other-vehicle at a first-distance when the automation-level is an autonomous-mode, and follow the other-vehicle at a second-distance greater than the first-distance when the automation-level is a manual-mode, i.e. human-driven.

### TECHNICAL FIELD OF INVENTION

This disclosure generally relates to a system for operating an automated vehicle, and more particularly relates to a system that operates a host-vehicle in accordance with an operation-rule that is selected based on an automation-level of an other-vehicle proximate to the host-vehicle.

### BACKGROUND OF INVENTION

Autonomous vehicles are expected to operate in a predictable manner rather than in an unpredictable manner as is sometimes the case for a human-driven vehicle operated by a human-operator.

### SUMMARY OF THE INVENTION

In accordance with one embodiment, a system for operating an automated vehicle in accordance with operation-rules that are based on an automation-level of an other-vehicle is provided. The system includes an automation-detector and a controller. The automation-detector conveys an automation-level indicated by an other-vehicle proximate to a host-vehicle. The controller is in communication with the automation-detector. The controller operates the host-vehicle in accordance with an operation-rule that is selected based on the automation-level of the other-vehicle.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a merge system in accordance with one embodiment; and

FIG. 2 is a traffic-scenario that may be encountered by the system of FIG. 1 in accordance with one embodiment.

### DETAILED DESCRIPTION

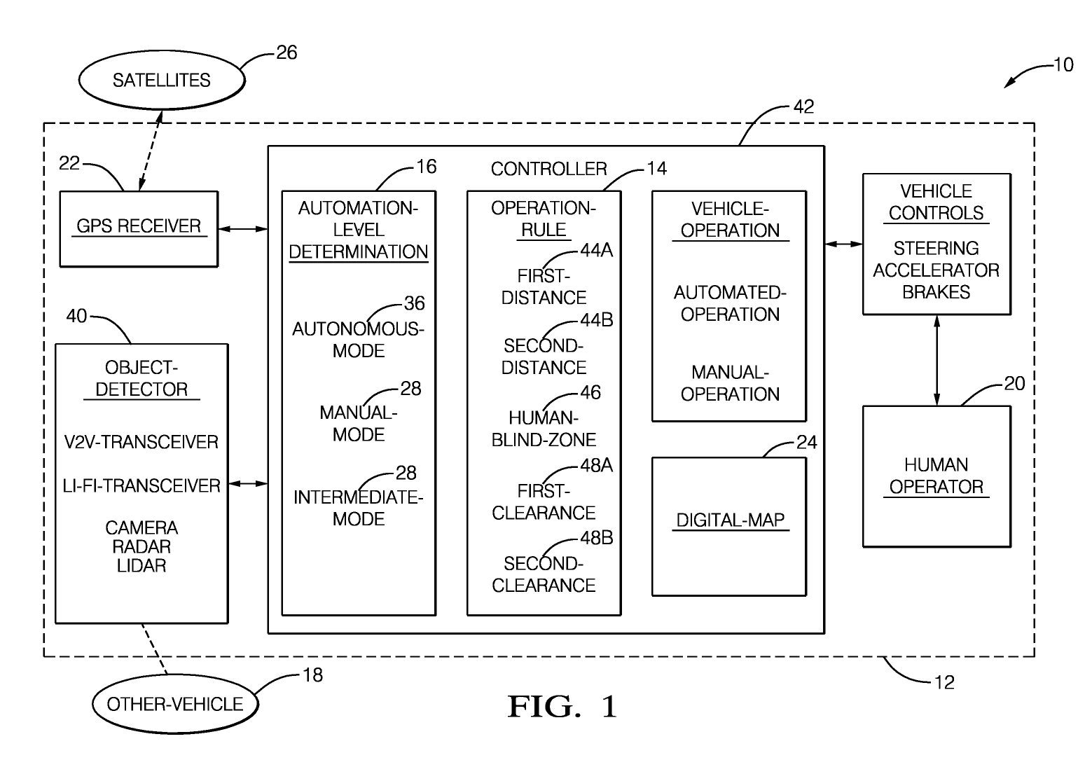

FIG. 1 illustrates a non-limiting example of a system 10 for operating an automated vehicle, for example a host-vehicle 12, in accordance with an operation-rule 14 that is determined or selected based on an automation-level 16 of an other-vehicle 18. As used herein, the term automated vehicle may apply to instances when the host-vehicle 12 is being operated in accordance with automated-operation, i.e. fully autonomous-operation, where a human-operator 20 of the host-vehicle 12 may do little more than designate a destination in order to operate the host-vehicle 12. However, fully automated-operation of the host-vehicle 12 is not a requirement. It is contemplated that the teachings presented herein are useful when the host-vehicle 12 is operated by manual-operation where the human-operator 20 is generally in control of the host-vehicle 12 and the degree or level of automation of the host-vehicle 12 may be limited to providing a warning about the other-vehicle 18, and/or momentary operation of the steering, accelerator, and/or brakes to, for example, avoid a collision with the other-vehicle 18.

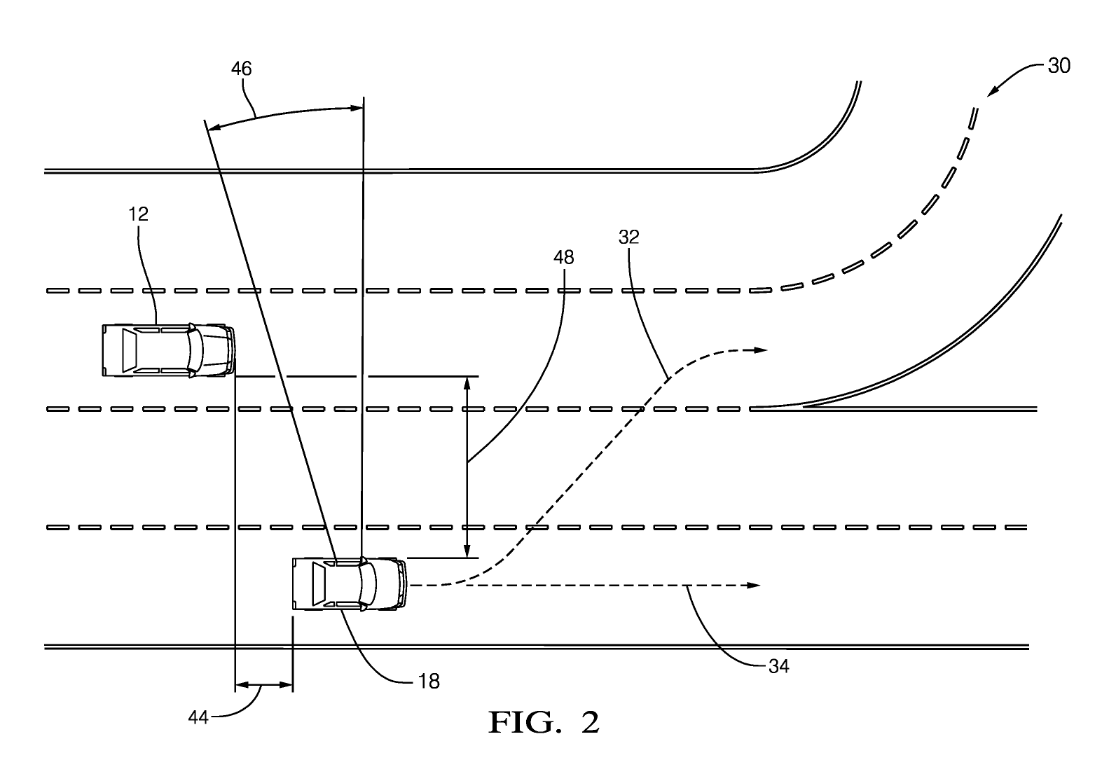

The system 10 may include a global-positioning-system-receiver 22 (GPS-receiver 22) that indicates a coordinate of the host-vehicle 12 on a digital-map 24 based on signals received from satellites 26. The digital-map 24 may be stored in the host-vehicle 12, or may be stored remotely, i.e. ‘in the cloud.’ The digital-map 24 may be useful to identify or forecast a traffic-scenario 30 (FIG. 2) where the other-vehicle 18, if operated in a manual-mode 28 by a human-driver (not shown), may suddenly perform an unexpected-maneuver 32, such as suddenly changing lanes, rather than continue straight and thereby perform an expected-maneuver 34, which is the likely situation if the other-vehicle is operated in an autonomous-mode 36. It is also contemplated that the host-vehicle 12 may be operated in an intermediate-mode 38 where partial automation is being used. For example, the speed-control (accelerator and brakes) of the host-vehicle 12 may be automated, but the steering of the host-vehicle 12 is in the control of the human-operator 20.

The system 10 includes an automation-detector 40 that conveys the automation-level 16 indicated by the other-vehicle 18 proximate to the host-vehicle 12. The automation-detector 40 may include any one or combination of a vehicle-to-vehicle transceiver (V2V-transceiver) that communicates using known dedicated short range communications (DSRC), a light fidelity transceiver (Li-Fi transceiver), a camera, a radar, and/or a lidar. The V2V-transceiver and/or the Li-Fi transceiver may be used to receive information broadcast by the other-vehicle 18 regarding the automation-level 16 of the other-vehicle 18, e.g. that the other-vehicle 18 is operating in the autonomous-mode 36 or the manual-mode 28. The camera may be used to detect a light (e.g. a blue-light) on the other-vehicle 18 that is illuminated when the other-vehicle 18 is being operated in the autonomous-mode 36. Alternatively, any combination of the camera, the radar, and/or the lidar may be used to monitor the behavior of the other-vehicle 18 with regard to speed-variation and/or lane-position variation. If the other-vehicle 18 seems to be well behaved with regard to speed-variation and/or lane-position variation, it may be presumed that the other-vehicle 18 is being operated in the autonomous-mode 36.

The system 10 includes a controller 42 in communication with the automation-detector 40 and optionally the GPS-receiver 22. The controller 42 may include a processor (not specifically shown) such as a microprocessor or other control circuitry such as analog and/or digital control circuitry including an application specific integrated circuit (ASIC) for processing data as should be evident to those in the art. The controller 42 may include memory (not specifically shown), including non-volatile memory, such as electrically erasable programmable read-only memory (EEPROM) for storing one or more routines, thresholds, and captured data. The one or more routines may be executed by the processor to perform steps for determining the automation-level 16 of the other-vehicle 18 based on signals received by the controller 42, and determining the operation-rule 14 by which the host-vehicle 12 will be operated, as will be described in more detail below. That is, the controller 42 operates the host-vehicle 12 in accordance with an operation-rule 14 that is selected based on the automation-level 16 (e.g. the autonomous-mode 36, the manual-mode 28, or the intermediate-mode 38) of the other-vehicle 18.

FIG. 2 is a non-limiting example of a traffic-scenario 30 that may be encountered by the host-vehicle 12 equipped with the system 10. Examples of different instances of the operation-rule 14 that were selected based on different values of the automation-level 16 will now be described with reference to FIG. 2.

In one non-limiting example, the system 10, or more specifically the controller 42 operates the host-vehicle 12 to follow the other-vehicle 18 at a selected-distance 44 that is selected based on the automation-level 16. For example, the host-vehicle 12 may follow at a first-distance 44A (FIG. 1), e.g. five meters, when the automation-level 16 of the other-vehicle 18 is the autonomous-mode 36, and follow the other-vehicle at a second-distance 44B, e.g. nine meters, which is greater than the first-distance 44A when the automation-level 16 is the manual-mode 28. That is, the host-vehicle 12 may follow the other-vehicle 18 at a greater value of the selected-distance 44 when the other-vehicle 18 is being operated in the manual-mode 28 so there is more time to react if the human-driver of the other-vehicle 18 performs an erratic-maneuver, e.g. the unexpected-maneuver 32.

In another non-limiting example, the controller 42 operates the host-vehicle 12 to avoid operating the host-vehicle 12 in a human-blind-zone 46 of the other-vehicle 18 when the automation-level 16 is the manual-mode 28, and allow operating the host-vehicle 12 in the human-blind-zone 46 of the other-vehicle 18 when the automation-level 16 is the autonomous-mode 36. Devices that are part of the automation-detector 40 may be used to determine a relative-location of the other-vehicle 18 relative to the host-vehicle 12, and a mathematical-model of were the human-blind-zone is located relative to the other-vehicle 18 may be used to determine when the host-vehicle 12 is or is not operating in the human-blind-zone 46 of the other-vehicle 18.

In another non-limiting example, the controller 42 operates the host-vehicle 12 to pass the other-vehicle 18 with a selected-clearance 48 that is selected based on the automation-level 16. While FIG. 2 shows a rather large clearance for the selected-clearance 48, this may not be unreasonable if the other-vehicle 18 is operating in the manual-mode 28 and is behaving very erratic such as when the human-driver is tired or intoxicated. It is however contemplated that the host-vehicle 12 and the other-vehicle 18 will be in adjacent lanes, and the selected-clearance will be a value that can be accommodated without the host-vehicle 12 changing lanes to put a vacant lane between the host-vehicle 12 and the other-vehicle 18 For example, the host-vehicle 12 may pass the other-vehicle 18 with first-clearance 48A, e.g. one-meter, when the automation-level 16 is the autonomous-mode 36, and pass the other-vehicle 18 with a second-clearance 48B, e.g. two-meters, which is greater than the first-clearance 48A when the automation-level 16 is the manual-mode 28. That is, the host-vehicle 12 may pass the other-vehicle 18 at a greater value of the selected-clearance 48 when the other-vehicle 18 is being operated in the manual-mode 28 so there is more time to react if the human-driver of the other-vehicle 18 performs an erratic-maneuver, e.g. weaves.

Accordingly, a system 10 for operating an automated vehicle in accordance with operation-rules that are based on an automation-level of an other-vehicle, a controller 42 for the system 10, and a method of operating the system 10 is provided. The system 10 operates the host-vehicle 12 to provide greater distance/clearance to the other-vehicle 18 when the other-vehicle 18 is being driven by a human-driver, i.e. operating in the manual-mode 28, as compared to when the other-vehicle is being operated in the autonomous-mode 36.

While this invention has been described in terms of the preferred embodiments thereof, it is not intended to be so limited, but rather only to the extent set forth in the claims that follow.

1. A system for operating an automated vehicle in accordance with operation-rules that are based on an automation-level of an other-vehicle, said system comprising:
an automation-detector that conveys an automation-level indicated by an other-vehicle proximate to a host-vehicle, wherein the automation-level includes an autonomous-mode, an intermediate-mode, and a manual-mode;
a controller in communication with the automation-detector, said controller operates the host-vehicle in accordance with an operation-rule that is selected based on the automation-level of the other-vehicle.

2. (canceled)

3. The system in accordance with claim 1, wherein the controller operates the host-vehicle to follow the other-vehicle at a first-distance when the automation-level is the autonomous-mode, and follow the other-vehicle at a second-distance greater than the first-distance when the automation-level is the manual-mode.

4. The system in accordance with claim 1, wherein the controller operates the host-vehicle to avoid operating the host-vehicle in a human-blind-zone of the other-vehicle when the automation-level is the manual-mode, and allow operating the host-vehicle in the human-blind-zone of the other-vehicle when the automation-level is the autonomous-mode.

5. The system in accordance with claim 1, wherein the controller operates the host-vehicle to pass the other-vehicle with a first-clearance when the automation-level is the autonomous-mode, and pass the other-vehicle with a second-clearance greater than the first-clearance when the automation-level is the manual-mode.
